(19) United States
(12) Patent Application Publication
(10) Pub. No.: US 2011/0289432 A1
(43) Pub. Date: Nov. 24, 2011

(54) Community-Based Moderator System for Online Content

(76) Inventor: Keith V. Lucas, Half Moon Bay, CA (US)

(21) Appl. No.: 12/784,915

(22) Filed: May 21, 2010

(51) Int. Cl. G06F 3/01; G06N 5/02

(52) U.S. Cl. 715/753; 706/47

(57) ABSTRACT

A community-based moderation system for online content has a computerized server connected to the Internet network and executing software (SW) from a machine-readable medium, a queuing function of the SW for queuing items for moderation, a recruiting function of the SW for recruiting potential moderators from an online community via the Internet, an interactive interface generated by the SW and displayable on computer appliances of recruited moderators, for displaying items for moderation and controls for carrying out moderation, and a reporting function associated with the interactive display enabling the moderator to report results of moderation.

### BACKGROUND OF THE INVENTION

1. Field of the Invention

The present invention is in the field of electronic data networking and pertains particularly to methods and apparatus for moderating online content.

2. Discussion of the State of the Art

With the advent of the well-known Internet network, many online communities have formed around popular Web sites offering social interaction, game play, or other online community-involved activities. Such popular Websites may host a very large number of members making up the online community that frequents the site and interacts with the site's offerings. In addition to a large number of community members, a very large volume of online content may be contributed to the site by members of the online community surrounding the site.

The nature of the online content may vary from community site to community site, but on the whole, the content is usually required to be non-offensive to the members of that particular community of users. The merits of online content may be questionable in many cases, and in some cases the content is illegal or otherwise highly offensive material. In addition to the requirement of content being non-offensive to members of the community, it generally must also be non-offensive to online visitors who may come into contact with the online materials.

One way to provide moderation of online content is through an automated parsing software (SW) adapted to detect offensive content such as offensive language. A lot of online content could be filtered through a content filter that eliminates content that has offensive language, such as in the title of description, summary of the content or the content itself if text. Visual content such as movies and photographs typically need to be viewed by a human being to determine if the content is offensive or non-offensive according to the standards of the online community surrounding the site.

The cost of moderating content can be significant for a site host. It is therefore desirable to reduce costs of moderating content. Therefore, what is clearly needed is community-based moderation system for moderating the online content contributed by community members. A system such as this would solve the problems stated above.

### SUMMARY OF THE INVENTION

The problem stated above is that low cost moderation of online content is desirable for a community Website, but many of the conventional means for moderating online content such as paid moderators also create more expense. The inventors therefore considered functional components of a moderated online community, looking for elements that exhibit interoperability that could potentially be harnessed to provide content moderation but in a manner that would not create more expense.

Most online communities are driven by cooperation and interaction between community members, one by-product of which is an abundance of new content, some of which may not be appropriate for viewing by some community members. Most such online communities employ paid moderators to conduct moderation of online content and software queues, data repositories, and moderation interface tools are typically part of the apparatus.

The present inventor realized in an inventive moment that if, at the point of need, moderators could be recruited dynamically from online community members, significant cost reduction for moderating online content might result. The inventor therefore constructed a unique moderation system that allowed community members to get involved in the moderation process, but constrained more difficult moderation tasks to paid professional moderators. A significant reduction in overall moderation costs for the community results, with no impediment to moderation efficiency created.

Accordingly, in an embodiment of the present invention, a community-based moderation system for online content is provided, comprising a computerized server connected to the Internet network and executing software (SW) from a machine-readable medium, a queuing function of the SW for queuing items for moderation, a recruiting function of the SW for recruiting potential moderators from an online community via the Internet, an interactive interface generated by the SW and displayable on computer appliances of recruited moderators, for displaying items for moderation and controls for carrying out moderation, and a reporting function associated with the interactive display enabling the moderator to report results of moderation.

In one embodiment the online community comprises members of a game site. Also in one embodiment the items for moderation include games, objects, images, and text. In various embodiments a number of moderators moderate one queue item at a time, the results reported as moderation is completed.

In some embodiments there may be a higher level of moderation for items that are neither allowed nor banned during a lower level of moderation, and in some embodiments the interactive interface function provides moderation dashboard views that include a moderator panel for visual moderation of items. The recruiting function may be an invitation campaign inviting persons from a list of pre-qualified members.

Another aspect of the invention a method for moderating online content is provided, comprising the steps of (a) executing software (SW) from a machine-readable medium by a computerized server connected to the Internet network; (b) queuing items for moderation by a queuing function of the SW; (c) recruiting potential moderators from an online community via the Internet by a recruiting function of the SW; (d) providing an interactive interface generated by the SW and displayable on computer appliances of recruited moderators, displaying items for moderation and controls for carrying out moderation; and (e) reporting results of moderation through a a reporting function associated with the interactive display.

In one embodiment of the method the online community comprises members of a game site. Also in one embodiment the items for moderation include games, objects, images, and text. In various embodiments a number of moderators moderate one queue item at a time, the results reported as moderation is completed.

In some embodiments of the method there is a higher level of moderation for items that are neither allowed nor banned during a lower level of moderation. Also in some cases the interactive interface provides moderation dashboard views that include a moderator panel for visual moderation of items. In some cases the recruiting function is an invitation campaign inviting persons from a list of pre-qualified members.

In yet another aspect of the invention, in an online community, a method for establishing a user as one of a pool of community-based moderators is provided, comprising the steps of (a) monitoring the user and collecting data about the user; (b) processing the data against a set of rules; (c) comparing the processed result against a pre-set threshold value; (d) depending on the results of (c) either inviting the user to be a moderator or ignoring the user; and (e) if the user is invited at step (d), receiving acceptance of the invitation from the user.

In one embodiment the online community is made up of members of a game site. Also in one embodiment step (a) is ongoing for every community member considered for moderator. Also in an embodiment, in step (d) inviting the user to be a moderator is accomplished by pushing a message to the user when the user logs into the community Website. The processed result may be a percentage average.

### BRIEF DESCRIPTION OF THE DRAWING FIGURES

FIG. 1 is an architectural overview of a gaming community practicing dynamic moderation of online content according to an embodiment of the present invention.

FIG. 2 is an exemplary screenshot of a system message presenting an invitation to moderate online content.

FIG. 3 is a block diagram illustrating a trust model for evaluating user reputation to qualify to moderate online content according to an embodiment of the present invention.

FIG. 4 is an exemplary screen shot of a browser nested moderation panel according to an embodiment of the present invention.

FIG. 5 is a process flow chart illustrating steps for recruiting moderators and moderating online content according to an embodiment of the present invention.

FIG. 6 is a process flow chart illustrating steps for qualifying a user for moderation of online content according to an embodiment of the present invention.

### DETAILED DESCRIPTION

The inventors provide a unique system for moderating community Website content in a manner that reduces costs of moderation and increases overall efficiency of moderating online content. The methods and apparatus of the present invention are described in enabling detail using the following examples which may include description of more than one embodiment of the present invention.

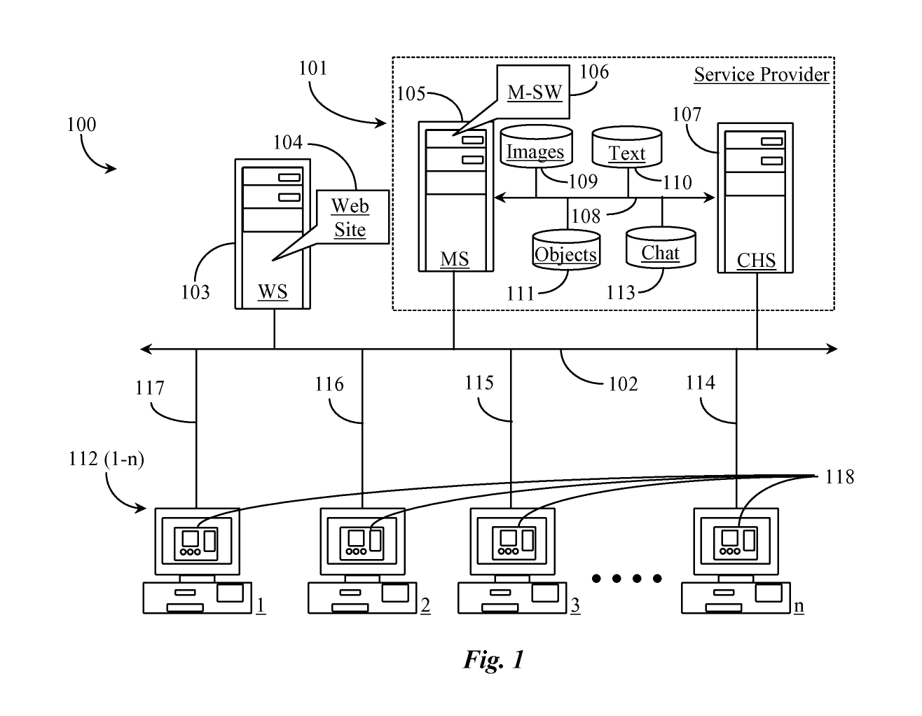

FIG. 1 is an architectural overview of a gaming network 100 practicing dynamic moderation of online content according to an embodiment of the present invention. Gaming network 100 includes an Internet network represented herein by a network backbone 102. Network backbone 102 represents all of the lines, equipment, and access points that make up the Internet as a whole including any connected sub-networks. Therefore there are no geographic limitations to the practice of the present invention.

Network backbone 102 may also be referred to herein as simply Internet 102. Internet 102 supports at least one Web server (WS) 103. Web server 103 includes a digital medium containing thereon all of the data and software required to enable function as a Web server hosting at least one Website. In this example WS 103 hosts a Web site 104. Web site 104 represents a community Website such as a gaming Website or some other type of community Website where content moderation is critical. In this example, a service provider 101 is illustrated and represents the domain of a company providing services through Website 104 hosted on WS 103.

Service provider 101 may be a game service provider operating Website 104 as a community-oriented game site where community members may play online games hosted through a gaming server (not illustrated) that would reside within the domain of service provider 101. A gaming server and supporting architecture is not illustrated in this example so as not to limit the type of service provider and community Website to online gaming. Service provider 101 may instead provide social interaction services through Website 104, for example.

Service provider 101 includes a moderation server (MS) 105. MS 105 comprises a digital medium that contains all of the software and data required to enable function as a moderation server. More particularly, MS 105 manages content for community-based moderation and manages the entire community-based moderation process according to at least one embodiment of the present invention. MS 105 has access to Internet 102 via an Internet access line. An instance of moderation software (M-SW) 106 is provided to and installed on a digital medium accessible to MS 105 for execution. M-SW 106 enables community moderation of online content including images, objects, and text.

Service provider 101 includes a local area network (LAN) 108 logically illustrated between MS 105 and a chat server (CHS) 107. CHS 107 includes a digital medium storing all of the data and software required to enable function as a chat server. CHS 107 has access to Internet 102 via an Internet access line. CHS 107 is not required to practice the present invention. In this example CHS 107 is optional and merely represents a fact that live chat interaction typically is moderated and therefore, moderation may be required for all live chat transactions in certain embodiments of the present invention.

LAN 108 supports several data repositories that are accessible to MS 105 and to CHS 107 in certain embodiments. MS 105 serves content to moderators. The content served may include but is not limited to images stored in an image repository 109, objects stored in an object repository 111, and text stored in a text repository 110. All of these repositories may in fact be included in a single mass storage medium, or may be separate as shown. Chat transcripts may be stored in a chat repository 113. The online content stored in the mentioned repositories may include newly created content that has not yet been moderated.

Community Website members 112 (1-n) are illustrated in this example and are represented by computer icons. Members 112 (1-n) are subscribers or otherwise clients of service provider 101 and have network access to services offered through Website 104 in this example. Member 112 (1) has Internet access via an Internet access line 117. Member 112 (2) has Internet access via an Internet access line 116. Member 112 (3) has Internet access through an Internet access line 115, and member 112 (n) has Internet access through Internet access line 114. Exact methods of Internet access may vary from community member to community member. For example, a community member operating a computing appliance such as appliance 112 (1), may connect to network backbone 102 through an Internet service provider (ISP) using a cable modem, digital subscriber line (DSL), broadband, WiFi, integrated services digital network (ISDN), satellite system, or dial-up modem. Internet access lines 117 through 114 are logically illustrated and do not represent actual connection architecture, which may vary widely.

Community members 112 (1-n) connect to Website 104 running on WS 103 when they want to interact with the site, such as playing interactive games, blogging, social interaction (chat), model building, and other available activities. The exact interaction types offered through the community Website may vary according to the type of the site. In this example, Website 104 is a gaming site offering the types of activities described above. One of the activities that can be performed at the site is moderation of online content. In this example, community members 112 (1-n) are potential content moderators for service provider 101. In this regard, each community member illustrated (112 (1), (2), (3), and (n)) has a moderation interface adapted to enable moderation of online content. These interfaces are moderation interface 118 running on computing appliances 112 (1-n).

Moderation interfaces 118 may be downloaded or served from MS 105 to computing appliances 112 (1-n), or provided in another manner. In practice of the invention a community member like community member 112 (1) may log onto Website 104 and may be invited to perform the task of content moderation for the company. The invitation may be a pop-up or other type of visual message appearing at the time of login to Website 104. If the invitation is accepted, the user may be connected to MS 105 running M-SW 106. M-SW 106 may serve moderation panels 118 to moderators whom have accepted invitations to moderate online content. MS 105 may also serve the required content for moderation to moderators operating moderation panel 118. For example, MS 105 aggregates and queues all of the content that requires moderation into one or more moderation queues.

Moderation panels 118, in one embodiment of the invention, display at least one moderation queue containing items for moderation. A user may select queued items working within the moderation panel upon which a visual image of the selected queued item is displayed in a main window within a moderation panel. The moderator can then determine whether or not the object is ok to publish in light of the community's expectations. It is noted herein that objects queued up for moderation may include three dimensional objects. Controls for rotating these objects may be provided in the moderation panel. Moderation is typically performed on each queued item while the moderator is online and connected to MS 105 running M-SW 106.

When the moderator is finished with an item he or she may submit the results, causing a next item in queue to appear in the main display of the moderation panels 118. Moderation content may include any items in repositories 109-111 or images, objects, and text. Moderation of chat content may be performed through a moderation panel such as moderation panel 118 without departing from the spirit and scope of the invention. The main scope of moderating in this example is moderating newly provided or created content before that content is published. Some content may be moderated before and after publishing. Some content may be moderated at a first level and then moderated at a higher level of moderation such as using a “super moderator”. Moderated objects or items may also be seeded into other moderator queues in order to evaluate the consistence of moderators. There are many possibilities.

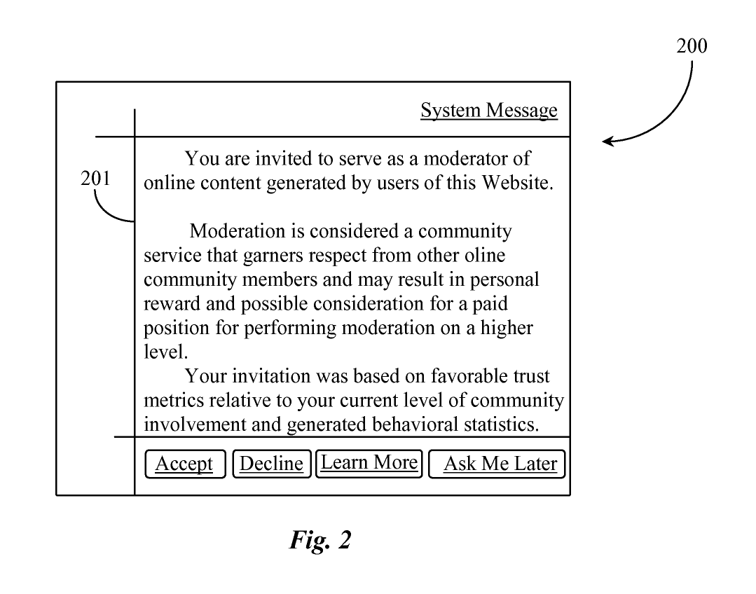

FIG. 2 is an exemplary screenshot of a system message 200 presenting an invitation to moderate online content. Message 200 is an example of a visual solicitation or invitation to a community member to server as a content moderator. Message 200 has a message body 201 that includes the typed message. The message may invite the user to serve as a moderator of online content. The message may inform the user of the value of being a moderator and may list some possible rewards and opportunities that might arise through service as a moderator. In a preferred embodiment the system selects potential moderators from the community membership based on trust metrics relative to the user's level of community involvement and generated behavioral statistics site wide.

Message 200 may appear to any community member interacting with the community Website. For example, message 200 may appear as a pop-up message during member site authentication. Message 200 may appear as a floating message or a static invitation on the community member's personal gaming page. Successful service over a longer period of time might lead to an opportunity to be compensated for moderation service. In some instances, highly successful volunteer moderators might be mined for recruitment as permanent professional moderators.

Message 200 includes an acceptance button, a declination button, a button to get more information about the opportunity, and a reminder button to prompt the system to ask again later. Accepting the offer may cause a redirection to a page on a moderation server so that a moderation interface or “moderation panel” like interface 118 previously described may be downloaded to a community member's computing appliance. A connection to the moderation server (MS) is required in order for content requiring moderation to be served into a queue represented in the user's moderation panel. In one embodiment all of the moderation is performed online at a moderation server like MS 105 described in FIG. 1. In this case each moderator may have their own personalized moderation panel. Items would be presented to the interface for the user to moderate while online and connected to the server.

In another embodiment the moderation panel might be downloaded from the moderation server, and objects may be loaded into a queue in the moderation panel. In this case the user may go offline and moderate items using his or her personal appliance. When finished, the user may re-connect to the moderation server and upload his or her moderation results (recorded by the panel interface) to the service. In this case the user may retain the moderation panel and have it loaded again at a next moderation opportunity.

In one embodiment there may be two or more different versions of a moderator interface or panel. For example, one version of the panel might be adapted for volunteer moderators and another version may be for “super moderators” or paid professionals having more moderation experience. Rewards for volunteer moderation may vary according to the nature of the company. In a gaming site, rewards might include virtual currency like game bucks, free game play, coupons for products from a gaming catalog, and the like. Remaining a candidate for moderator may depend on maintenance of a trust level with the service. If the trust value of a moderator slips below a threshold then he or she may be disqualified from moderating until and if the trust level for that user rises above the pre-set threshold.

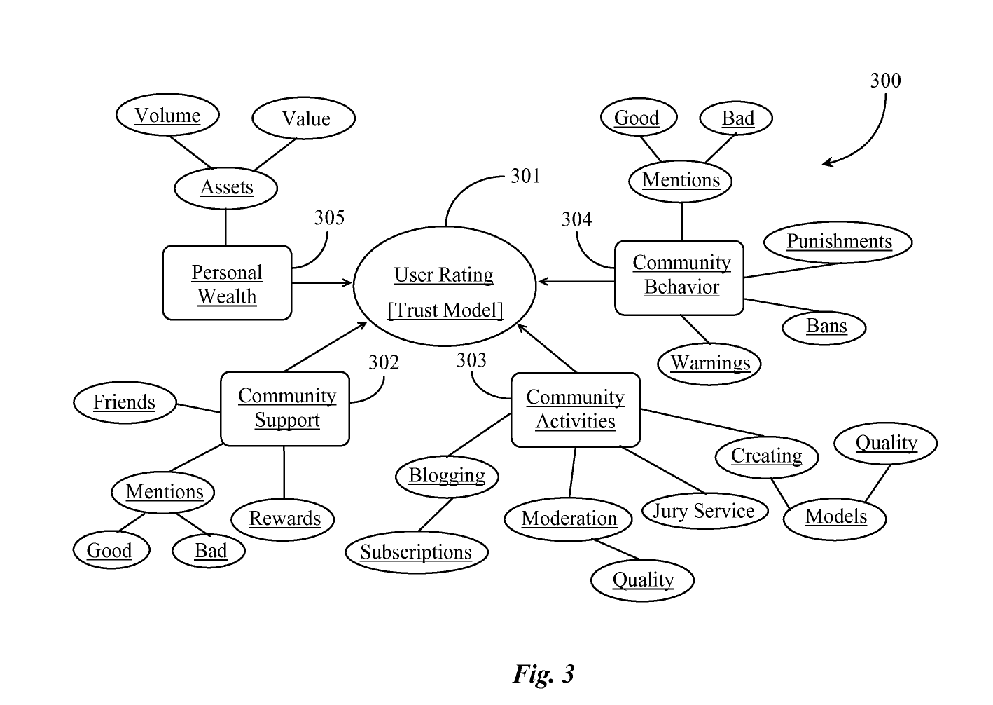

FIG. 3 is a block diagram illustrating a trust model 300 for evaluating user reputation to qualify a user to moderate online content according to an embodiment of the present invention. Trust model 300 has a main object 301, which is a user rating. Object 301 has, in association with it, other objects containing informational attributes that might be evaluated in forming the user rating for each community member that frequents the Website.

Object 301 is associated with a community support object 302. Community support object 302 defines the level of community support afforded the community member as a result of the member's ongoing interactions with the Website. Community support object includes the attribute friends. The attribute friends may define the number of friends the user has made since joining the community. The number of friends a user has may have an effect on the overall user rating used to determine if a user may be solicited to moderate content.

Object 302 has an attribute mentions. The attribute defines all of the comments that other users may have attributed to this user. Mentions may include good comments as well as comments that may be considered bad for the user. Community support object has an attribute rewards. The attribute rewards defines all of the rewards that the user has received from the community. Any rewards received may add to the overall rating of the user for moderation of online content.

User rating object 301 has association to a community activities object 303. Community activities object 303 defines all of the activities of the community website that the user has engaged in or participated in. Community activities object 303 has a blogging attribute with a subscriptions attribute. The blogging attribute confirms that the user has one or more blogs at the site and the subscriptions attribute defines the number of subscribers to the blog or blogs authored by the user.

Community activities object 303 includes a moderation attribute with a quality attribute that confirms the user has already performed moderation for the community Website and the quality rating for that moderation. The quality rating might be an average value for all of the moderation performed by the user since the user became a community member. In one embodiment of the invention, the community Website is a gaming Website and the user has performed jury service for the community to help resolve one or more issues of infringement between community members.

Object 303 includes an attribute creating that confirms the user has created models or other products for the community. A quality attribute might be applied to models created and the average quality value might be used to help deduce an overall user rating. Object 301 has association to a community behavior object 304. Community behavior object 304 has the attributes warnings, bans, and punishments. These attributes define any warnings the user may have received, bans from services or community site areas, or games that the user may have been placed on, and any formal punishments the user may have received from the community. These attributes are typically negative and have negative effect on overall user rating. A time element may be added to such negative instances where community behavior resulted in a warning, ban or a punishment or a combination thereof such that the specific warning, ban, or punishment drops off of the record after a certain time period like 30 days, for example.

Object community behavior also has an attribute mentions defining any good or bad mentions attributed to the user relative to community behavior. Object 301 has association to a personal wealth object 305. Personal wealth object 305 has the attribute assets that define what the user has accumulated in the way of property since becoming a community member. Assets may have attributes value and volume defining the number of assets and the average value or all of the assets or the personal wealth figure for that user.

Trust model 301 may evolve and change as it is being updated with new information. Therefore, the overall user rating value for qualifying to be a moderator may rise and fall accordingly. Likewise the user is competing with all of the other community site members who all have their own trust models. In one embodiment of the present invention, all community site members are provided trust models and the system continually updates and maintains the trust metrics for each user. In this embodiment, only those members who have ratings exceeding a pre-set minimum value may be considered for moderation services. It is noted herein that the value may be raised or lowered depending on need of the community site. For example, if the standard is set so high that moderators are hard to come by then it might be lowered somewhat.

In a preferred embodiment, the trust metrics provide the system with knowledge of who might make a good moderator. Several moderators may be pre-qualified, invited and working on a volunteer basis on the same items requiring moderation by the system before publishing. This provides lower costs associated with moderation and sufficient quality control of the moderation process.

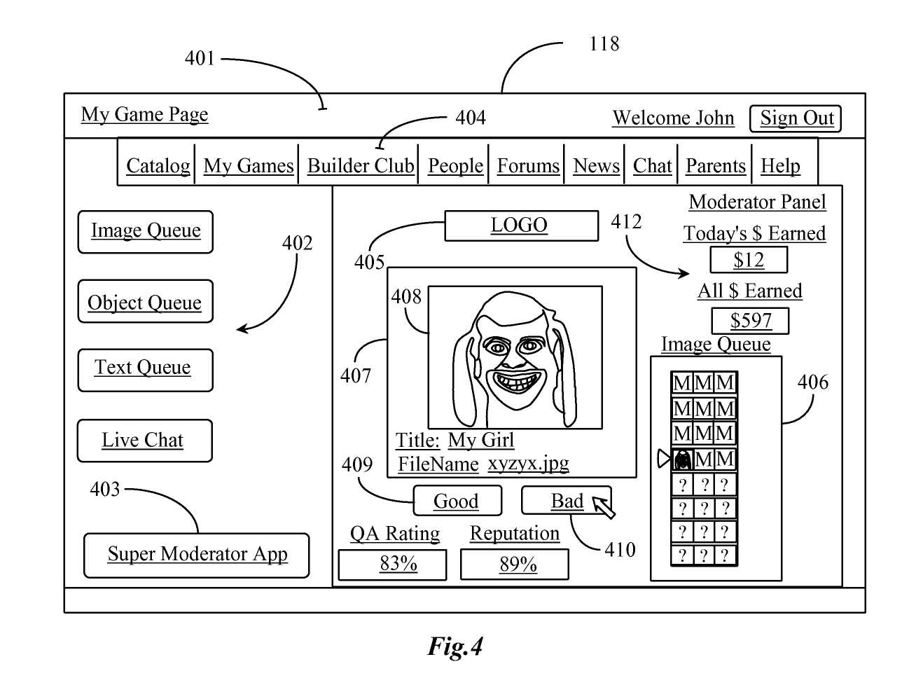

FIG. 4 is an exemplary screen shot of the browser-nested moderation panel 118 of FIG. 1 according to an embodiment of the present invention. Panel 118 has a title bar 401 that identifies the page as “My Game Page”, and welcomes the user “John”. A sign out option is illustrated presuming the John is currently signed in. Panel 118 may be nested in a community member's Web browser. In one embodiment it may be a server-side object (interface) accessible to community members qualifying to be moderators. In another embodiment it may be a downloaded installation from a moderation server.

In this example, panel 118 nests into the moderator's Web browser. Panel 118 includes a community Website menu 404 for navigation purposes. Menu 404 includes all of the options available on the community Website. Moderator panel 118 includes a sidebar area that contains various moderation options 402. Moderation options 402 refer to queues from which the moderator might work. The options are Image queue, Object queue, Text queue, and a direct link to Live Chat for realtime chat session moderation. A link 403 is provided in panel 118 to an application for becoming a super moderator. A super moderator has more experience than a volunteer moderator and may be paid for their services by contract. To apply for super moderator, an application might be required. In one embodiment, option 403 may be a link to a super moderator queue that is loaded with objects that are traditionally harder to moderate.

It is important to note herein that different moderation queues may be provided to accommodate the needs of the company. For a gaming site, moderation streams might be person, chat, game, assets, and forum. Game moderation may include moderating individual game components as well as interactive aspects of the game including any visible names and labels attached to avatars, components, etc. In one embodiment, several moderators might be set up to simultaneously moderate the same content. In such a case, a unanimous decision or vote by all the moderators may be required to pass or fail an item relative to community standards. In a case where not all moderators agree on an item, or otherwise a unanimous decision cannot be made the item may go to a super moderator queue where the item may be moderated again. In one embodiment items that are not unanimously decided on are sent to arbitration where two or more arbitrators debate the issues and finally resolve whether the item will pass community standards or fail community standards.

In one embodiment, moderators may specialize in certain moderation roles defined by the system. A moderation role might be a community moderator, a community arbitrator, a super moderator, etc. Moderation roles might be limited by age, for example. In one embodiment moderation panel 118 may be a small part of a larger dashboard view. In one embodiment there may be more than one type of dashboard view for more than one type of moderator role. For example, a dashboard view might be made available to an administrator while another dashboard view might be available to a super moderator, while yet another version is provided to an arbitrating moderator. In one embodiment community moderation entails simultaneous voting on many items with some debate. Items may be presented in multi-user queues, or they may be presented on dynamically generated Webpages that are interactive and where votes and comments may be tallied.

Panel 118 includes a company logo 405. Logo 405 may represent the service provider such as a company hosting a gaming site. Panel 118 has an image queue 406 displayed therein and loaded with images for moderation. Each image is loaded into queue 406 as a thumbnail image that is not necessarily visible to the moderator until the image is selected. In this example, images that have been moderated are marked M and images hat have not yet been moderated are marked with a question mark (?). A pointer shows the place in queue from where the moderator is working, and the image currently being moderated is image 408 displayed in a main viewing window 407.

Image 408 may be moderated according to community standards. For example, the title and or filename may be offensive as well as the image itself. If the image is a three-dimensional object, the moderator may be provided with manipulation tools for rotating the object to see all of the views during the moderation process. A button 409 labeled “good” is provided for the moderator to indicate that the image meets or exceeds the standards of the community. A button 410 labeled “bad” is provided for the moderator to indicate that the image fails to meet the standards of the community. In this example, image queue 406 records the results and when the queue is emptied the moderator may elect to load the queue with more items to moderate.

Information related to the moderator may also be presented within moderation panel 118. For example, information items 412 include the current total of dollars earned during moderation for the current day, and the total number of dollars earned as a moderator. In this example, a QA rating for the moderator is 83% and an overall reputation for the moderator is 89%. The QA rating may represent the average quality of moderation provided by this moderator. The overall reputation of the moderator may change in real time as conditions change and as updates are made to information about the moderator.

A pipeline may exist where all content requiring moderation is filtered through one or more automated filters before reaching multi-user queues for human moderation. Items that fail to get unanimous decisions may be sent to arbitration and may garner comments from community arbitrators. Those items that cannot be allowed or banned based on the arbitration process may be directed to a super moderation queue where a highly experienced moderator will pass judgment. In some cases, a super moderator may be empowered to hand out warnings, bans, and punishments to contributors of sub-standard content.

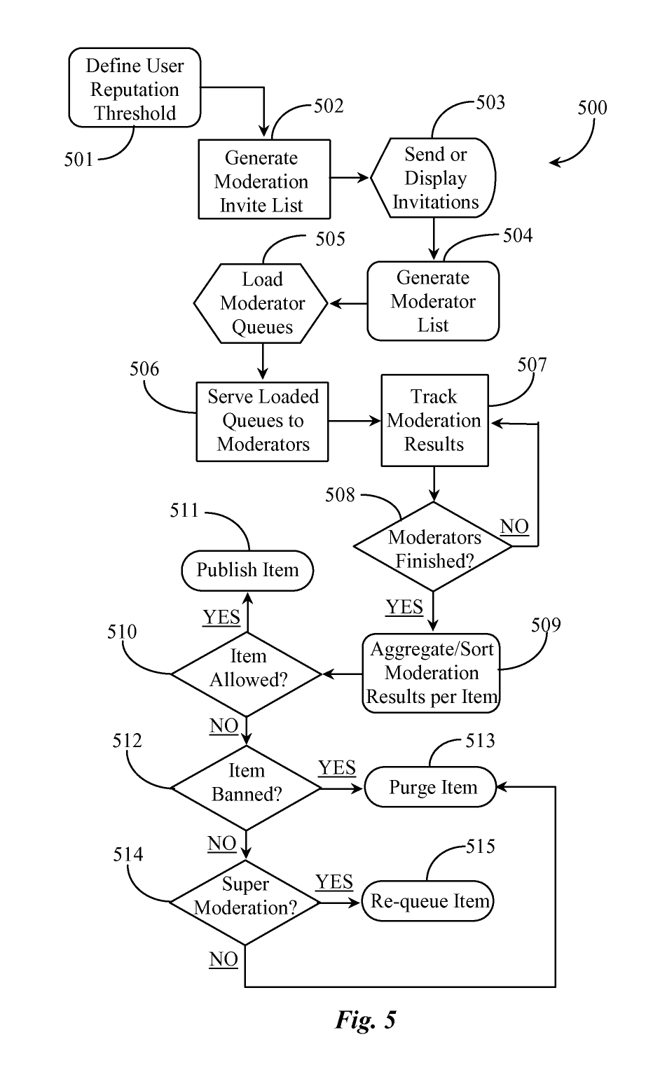

FIG. 5 is a process flow chart 500 illustrating steps for recruiting moderators and moderating online content according to an embodiment of the present invention. At step 501, a user reputation threshold might be defined by the system. A reputation threshold is a value that defines the level of good reputation a community member must posses in order to be accepted for any role of moderation. In one embodiment there is more than one threshold, one for community moderation, and one for super moderation.

At step 502, the system generates an invitation list containing the names and contact data for all of the community members considered candidates for moderation services. At step 503 the system may send out invitations or push them into the Web sessions of community members. In one embodiment community members that have been pre-qualified to perform moderation service are recruited by serving interactive pop-up message into the login interface to the community Website. Community members may have the option of declining or delaying the process.

At step 504, the system generates a moderator list from those potential moderators whom have accepted the duty by interacting with the invitation message. The system may quickly get a complete list of willing community members and can modify that list according to current conditions like volume of content to be moderated and so on. Having the list of moderators, the system may load moderator queues with the online content to be moderated at step 505. In one embodiment loaded queues are made accessible through an individualized personal moderator panel downloaded to or otherwise made accessible to all of the moderators on the moderator list. In one embodiment moderators may subscribe to certain online content categories or queues that they may have a preference or special talent for. In another embodiment content is mixed and queued so that all moderators have a similar moderation experience.

In this example, the loaded queues are served to moderator interfaces at step 506. At step 507, the system tracks moderation results. Moderation results are fed back into the reputation equation to further refine standard criteria for moderation. At step 508 the system determines if the moderators are finished moderating an item. In one aspect a number of moderators will be fed the same items in their queues and the system determines when a first item is finished before collecting the moderation results for the item. In a variation of this aspect, a number of moderators share a single queue and the items are served to the moderator interface panels by the queue system.

If at step 508 the system has determined that moderation is not finished the process may loop back top step 507 for continued tracking If at step 508 the system has determined that moderation is finished for an item, the system aggregates the moderation results and sorts the results per item at step 509. In one aspect the results are reported to a central location from the moderators such as to moderation server (MS) 105 described further above in this specification. In another aspect the results may be collected from moderator panels periodically.

At step 510 the system determines for an item, if that item is allowed per moderation results for the item. If the item is allowed at step 510, then the item may be published at step 511. If at step 510 the system determines that the item is not allowed, the system determines if the item is banned at step 512. In one aspect of the method, wherein a number of moderators have moderated one item from a queue of items, the rule is that 100% of the moderators have the same vote to allow or to ban an item. Therefore, two decision steps may be appropriate where a possibility is that an item is neither allowed nor banned.

If at step 512 the system determines that the item is banned, then the item may be purged from the system at step 513. In this case the creator or author or contributor of the item might be notified of the problem. Depending on the nature of the item and the nature of why it was banned, the system may warn or ban the author of the item from a specific site area, page, game, or otherwise punish or restrict the user in some way. If the item is not banned at step 512, then the system decides if the item will be sent to a super moderator at step 514. This may be the case where the first round of moderation is community-based arbitration by several or more moderators. The super moderator would be one of more experience than the community moderators. A super moderator may, in one aspect, be a paid position that is always made accessible to any of the community moderators (based on performance). This may serve as at least partial incentive to serve as a moderator of content for the site. However, it is noted herein that two separate tiers of moderation are not required in order to practice the present invention.

If the system determines in step 514 that the item will not be sent to a super moderator after not being allowed or banned, then that item may be purged from the system at step 513. If the system determines that the item will be sent to a super moderator at step 514, then that item is re-queued for a super moderator at step 515. A threshold of importance might be placed on an item being moderated that would be the criteria for sending an item that was not allowed or banned to a super moderator. If the value assigned to the item is below the threshold then the item might be purged.

If the value assigned to the item is equal to or greater than the threshold the item may be re-queued for a super moderator that is a human moderator with the experience to make a final judgment. In one aspect, further steps are provided for super moderation such as a decision whether the item will be allowed or banned with the process resolving to either step 513 in case the item is banned, or to step 511 if the item is allowed. A super moderator may also have power to render a warning, ban or some other punishment for the creator of the banned item such as if the item was purposely offensive, etc.

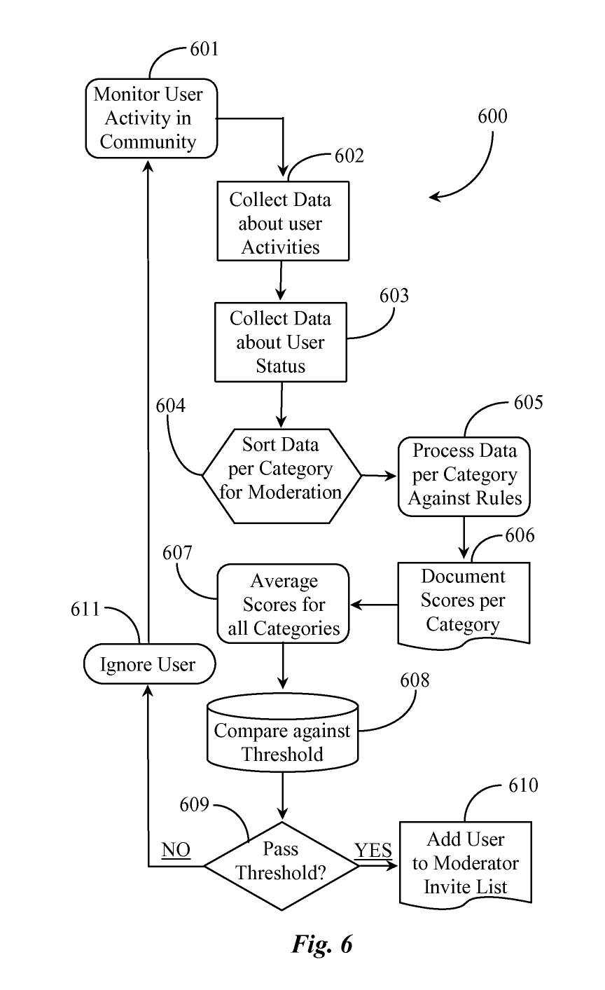

FIG. 6 is a process flow chart 600 illustrating steps for qualifying a user for moderation of online content according to an embodiment of the present invention. At step 601 the system monitors user activity within the online community. Step 601 is ongoing for every community member that interacts with the offerings of the site. At step 602 data is collected about user activities. Step 602 is ongoing for every community member. Data about user status may be collected at step 603. User status may cover friends, assets, bans, warnings, and the like accumulated over time less any time constraints set for keeping specific data.

At step 604 the system may sort collected data relative to specific categories of data used to determine fitness for moderation work. At step 605 the sorted data may be processed per category for a user against one or more business rules. At step 606 the system may document the scores achieved per category. The absence of data for a category for a user might positively or negatively affect overall reputation rating. At step 607 all of the per-category scores for a user are averaged over all the categories. The system compares the average for the user against a threshold value.

At step 609 the system determines if the averaged score for the user passes the threshold. If the average score passed or exceeded the threshold at step 609, the user is added to a moderator invitation list for a next round of moderator invitations to participate in moderating online content. If a score for a user does not pass the threshold test, the system may ignore the user at step 611. The process moves back to step 601 for monitoring user activity. Process of flow chart 600 may contain fewer or more steps without departing from the spirit and scope of the present invention.

The order of some steps may also be altered without departing from the spirit and scope of the present invention. For example, step 603 may come before step 602. The steps may also be performed in tandem. Once a user is in the system and has been considered for invitation to moderation, the data stored about the user including activity and status of the user is updated periodically. When the system requests data about the user to process, the latest data is used. Some data may be purged after collection if the data had a time constraint relative to how long the data could be retained. For example, a ban from creating a model may only be in effect for 30 days, after which the information would be purged from the system.

The system of the present invention may be practiced with any online community that has online content that requires moderation. In one embodiment the system includes functions for auditing and management of moderators. Auditing may include profiling a community population to come up with a content rating system. Moderators may be individually ranked both pre-moderation and post moderation. Percentages of content that is arbitrated may be compared with percentage that is decided to be allowed or banned with 100% volume tracking. Management function can include manually banning moderators, manually assigning moderator roles, and managing group message moderation.

It will be apparent to one with skill in the art that the community-based moderation system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A community-based moderation system for online content comprising:
a computerized server connected to the Internet network and executing software (SW) from a machine-readable medium;
a queuing function of the SW for queuing items for moderation;
a recruiting function of the SW for recruiting potential moderators from an online community via the Internet;
an interactive interface generated by the SW and displayable on computer appliances of recruited moderators, for displaying items for moderation and controls for carrying out moderation; and
a reporting function associated with the interactive display enabling the moderator to report results of moderation.

2. The moderation system of claim 1 wherein the online community comprises members of a game site.

3. The moderation system of claim 1 wherein the items for moderation include games, objects, images, and text.

4. The moderation system of claim 1 wherein a number of moderators moderate one queue item at a time, the results reported as moderation is completed.

5. The moderation system of claim 4 further including a higher level of moderation for items that are neither allowed nor banned during a lower level of moderation.

6. The moderation system of claim 1 wherein the interactive interface function provides moderation dashboard views that include a moderator panel for visual moderation of items.

7. The moderation system of claim 1 wherein the recruiting function is an invitation campaign inviting persons from a list of pre-qualified members.

8. A method for moderating online content comprising the steps of:
(a) executing software (SW) from a machine-readable medium by a computerized server connected to the Internet network;
(b) queuing items for moderation by a queuing function of the SW;
(c) recruiting potential moderators from an online community via the Internet by a recruiting function of the SW;
(d) providing an interactive interface generated by the SW and displayable on computer appliances of recruited moderators, displaying items for moderation and controls for carrying out moderation; and
(e) reporting results of moderation through a a reporting function associated with the interactive display.

9. The method of claim 8 wherein the online community comprises members of a game site.

10. The method of claim 8 wherein the items for moderation include games, objects, images, and text.

11. The method of claim 8 wherein a number of moderators moderate one queue item at a time, the results reported as moderation is completed.

12. The method of claim 11 further including a higher level of moderation for items that are neither allowed nor banned during a lower level of moderation.

13. The method of claim 8 wherein the interactive interface provides moderation dashboard views that include a moderator panel for visual moderation of items.

14. The method of claim 8 wherein the recruiting function is an invitation campaign inviting persons from a list of pre-qualified members.

16. In an online community, a method for establishing a user as one of a pool of community-based moderators, comprising the steps of:
(a) monitoring the user and collecting data about the user;
(b) processing the data against a set of rules;
(c) comparing the processed result against a pre-set threshold value;
(d) depending on the results of (c) either inviting the user to be a moderator or ignoring the user; and
(e) if the user is invited at step (d), receiving acceptance of the invitation from the user.

17. The method of claim 16 wherein the online community is made up of members of a game site.

18. The method of claim 16 wherein step (a) is ongoing for every community member considered for moderator.

19. The method of claim 16 wherein in step (d) inviting the user to be a moderator is accomplished by pushing a message to the user when the user logs into the community Website.

20. The method of claim 16 wherein in step (c) the processed result is a percentage average.
